(19) United States
(12) Patent Application Publication
(10) Pub. No.: US 2025/0174412 A1
(43) Pub. Date: May 29, 2025

(54) SOLID ELECTROLYTIC CAPACITOR

(71) Applicant: Murata Manufacturing Co., Ltd., Nagaokakyo-shi (JP)

(72) Inventors: Wataru ONISHI, Nagaokakyo-shi (JP); Kyotaro MANO, Nagaokakyo-shi (JP); Yasutake FUKUDA, Nagaokakyo-shi (JP)

(21) Appl. No.: 19/038,972

(22) Filed: Jan. 28, 2025

Related U.S. Application Data
(63) Continuation of application No. PCT/JP2023/027731, filed on Jul. 28, 2023.

(30) Foreign Application Priority Data
Aug. 2, 2022 (JP) 2022-123086

(51) Int. Cl. H01G 9/048; H01G 9/15

(52) U.S. Cl. CPC H01G 9/048; H01G 9/15

(57) ABSTRACT

A solid electrolytic capacitor that includes: a sheet multilayer body having a plurality of flat film-shaped capacitor elements and a plurality of flat film-shaped cathode-electrode electrode foils alternately stacked with each other, each of the plurality of flat film-shaped capacitor elements comprising a flat film-shaped anode-electrode electrode foil having a porous portion in a predetermined depth from the surface, a dielectric layer on the porous portion, and a solid electrolyte layer on the dielectric layer; a first metal portion at an end portion of the anode-electrode electrode foil; and an insulating resin sealing the sheet multilayer body, wherein a first pore diameter of the first metal portion is larger than a second pore diameter of the porous portion of the anode-electrode electrode foil.

### CROSS REFERENCE TO RELATED APPLICATIONS

The present application is a continuation of International application No. PCT/JP2023/027731, filed Jul. 28, 2023, which claims priority to Japanese Patent Application No. 2022-123086, filed Aug. 2, 2022, the entire contents of each of which are incorporated herein by reference.

### TECHNICAL FIELD

The present disclosure relates to a solid electrolytic capacitor including a multilayer body obtained by alternately stacking a plurality of capacitor elements and a plurality of cathode electrodes.

### BACKGROUND ART

Patent Literature 1 discloses a method of manufacturing a solid electrolytic capacitor and the solid electrolytic capacitor. The solid electrolytic capacitor disclosed in Patent Literature 1 includes a plurality of flat film-shaped capacitor elements and a plurality of metal foils (cathodes). The flat film-shaped capacitor elements each include a foil-shaped valve metal substrate, a dielectric layer provided in a porous portion and on a surface of the valve metal substrate, and a solid electrolyte layer provided on a surface of the dielectric layer.

More specifically, the following configuration is provided. The porous portion in the capacitor elements of Patent Literature 1 is impregnated with an insulating resin (a mask agent). Furthermore, an insulating adhesive agent is provided in a frame shape in this insulating resin. Then, the solid electrolyte layer is provided in the frame of the insulating adhesive agent. The flat film-shaped capacitor elements and the metal foils are alternately stacked, which thus provides an element multilayer body. Then, an external electrode in this solid electrolytic capacitor is provided by using conductive paste and Ni/Sn plating at an end portion of the element multilayer body.

[Patent Literature 1] Japanese Unexamined Patent Application Publication No. 2019-79866

### BRIEF SUMMARY OF THE DISCLOSURE

The solid electrolytic capacitor disclosed in Patent Literature 1 has constant airtightness. In other words, the evaporation of moisture that intrudes inside during an MSL reflow may cause a rapid increase in internal pressure. As a result, a crack occurs inside the solid electrolytic capacitor and may reach the end portion of the element multilayer body. When such a crack occurs in a manufacturing process, Ni/Sn plating intrudes into this crack, which may cause an LC failure in terms of long-term reliability.

In view of the foregoing, exemplary embodiments of the present disclosure are directed to provide a solid electrolytic capacitor capable O significantly reducing occurrence of a crack and achieving high reliability.

A solid electrolytic capacitor according to the present disclosure includes: a sheet multilayer body having a plurality of flat film-shaped capacitor elements and a plurality of flat film-shaped cathode-electrode electrode foils alternately stacked with each other, each of the plurality of flat film-shaped capacitor elements comprising a flat film-shaped anode-electrode electrode foil having a porous portion in a predetermined depth from the surface, a dielectric layer on the porous portion, and a solid electrolyte layer on the dielectric layer; a first metal portion at an end portion of the anode-electrode electrode foil; and an insulating resin sealing the sheet multilayer body, wherein a first pore diameter of the first metal portion is larger than a second pore diameter of the porous portion of the anode-electrode electrode foil.

In such a configuration, gas, even when being generated due to the evaporation of moisture included in the inside of the solid electrolytic capacitor, is easy to be discharged to the first metal portion. In other words, the increase in internal pressure of the solid electrolytic capacitor is able to be reduced. The occurrence of a crack in the inside of the solid electrolytic capacitor is significantly reduced.

According to the present disclosure, a solid electrolytic capacitor capable of significantly reducing occurrence of a crack and achieving high reliability is able to be provided.

### BRIEF DESCRIPTION OF THE DRAWINGS

FIG. 1 is a side cross-sectional view showing a configuration of a solid electrolytic capacitor according to a first exemplary embodiment of the present disclosure.

FIG. 2A is a side surface cross-sectional view showing a configuration of a pair of a capacitor element and a cathode electrode before individualization, FIG. 2B is a side surface cross-sectional view showing the configuration of the capacitor element before individualization, and FIG. 2C is a side surface cross-sectional view showing a configuration of a pair of a capacitor element and a cathode electrode after individualization.

FIG. 3A and FIG. 3B are side surface cross-sectional views showing an overview configuration of the solid electrolytic capacitor.

FIG. 4 is an external perspective view of an overview of the solid electrolytic capacitor.

FIG. 5 is a view schematically showing a flow of gas generated in the solid electrolytic capacitor.

FIG. 6 is a flowchart showing an example of a schematic flow of a method of manufacturing the solid electrolytic capacitor according to the present exemplary embodiment.

FIG. 7 is a flowchart showing an example of a process

step of forming a capacitor element sheet.

FIG. 8A is an external perspective view showing a shape of an anode electrode of the capacitor element before individualization, and FIG. 8B is an external perspective view showing a shape of the capacitor element before individualization.

FIG. 9 is an external view of the capacitor element in a multi state.

FIG. 10 is an external perspective view showing a shape of the cathode electrode before individualization.

FIG. 11 is a flowchart showing an example of a process step of forming a sheet multilayer body.

FIG. 12A and FIG. 12B are external perspective views showing a state in which a dam is provided on the capacitor element sheet.

FIG. 13A and FIG. 13B are external perspective views showing a state in which a second dam and a first adhesive agent are provided on the capacitor element sheet.

FIG. 14A and FIG. 14B are exploded perspective views showing a state in which the capacitor element sheet and a cathode electrode sheet are stacked on each other.

FIG. 15A is a perspective view showing a state in which the capacitor element sheet in a multi state and the cathode electrode sheet are stacked on each other, and FIG. 15B is an external perspective view showing a state in which the capacitor element sheet in a multi state and the cathode electrode sheet are stacked on each other.

FIG. 16 is a flowchart showing an example of a process step of forming a first metal portion and a second metal portion.

FIG. 17 is a side cross-sectional view showing an overview configuration of a solid electrolytic capacitor according to a second exemplary embodiment of the present disclosure.

FIG. 18 is a side cross-sectional view showing an overview configuration of a solid electrolytic capacitor according to a third exemplary embodiment of the present disclosure.

FIG. 19 is a side cross-sectional view showing an overview configuration of a solid electrolytic capacitor according to a fourth exemplary embodiment of the present disclosure.

### DESCRIPTION OF EXEMPLARY EMBODIMENTS

### First Exemplary Embodiment

A solid electrolytic capacitor according to a first exemplary embodiment of the present disclosure and a method of manufacturing this solid electrolytic capacitor will be described with reference to the drawings.

### Description of Schematic Configuration of Solid Electrolytic Capacitor 1

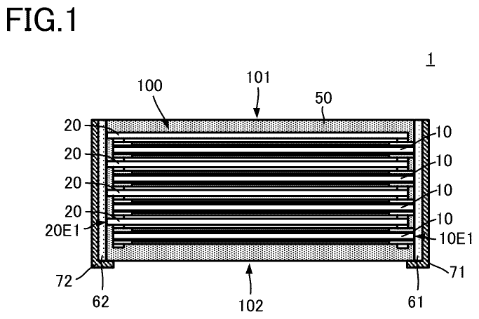

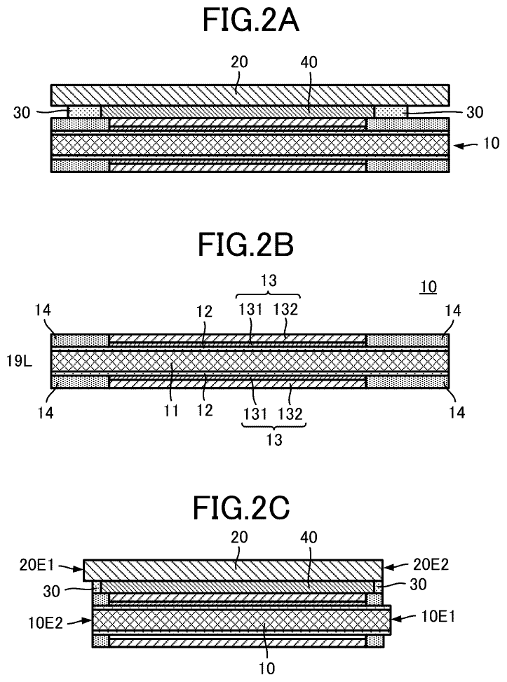

First, a structure of the solid electrolytic capacitor according to an exemplary embodiment of the present disclosure will be described. FIG. 1 is a side cross-sectional view showing a configuration of the solid electrolytic capacitor according to the first exemplary embodiment of the present disclosure. It is to be noted that, in FIG. 1, in order to make the drawing easy to see, only an insulating resin and an external electrode are indicated by hatching. FIG. 2A is a side surface cross-sectional view showing a configuration of a pair of a capacitor element and a cathode electrode before individualization. FIG. 2B is a side surface cross-sectional view showing the configuration of the capacitor element before individualization. FIG. 2C is a side surface cross-sectional view showing a configuration of a pair of a capacitor element and a cathode electrode after individualization.

As shown in FIG. 1, FIG. 2A, FIG. 2B, and FIG. 2C, a solid electrolytic capacitor 1 includes a capacitor element multilayer body 100, an insulating resin 50, metal films 61 and 62, and external terminal electrodes 71 and 72. The capacitor element multilayer body 100 includes a plurality of flat film-shaped capacitor elements 10 and a plurality of flat film-shaped cathode electrodes 20. It is to be noted that, although FIG. 1 shows four flat film-shaped capacitor elements 10 and four cathode electrodes, the number of pieces (number of sheets) is not limited to this example. It is to be noted that the cathode electrode 20 corresponds to the “cathode-electrode electrode foil” in the present disclosure. In addition, the metal films 61 and 62 correspond to the “first metal portion” in the present disclosure, and the external terminal electrode 71 corresponds to the “second metal portion” in the present disclosure. The metal film 61 is used as an anode-side current collecting electrode of the solid electrolytic capacitor 1, and the metal film 62 is used as a cathode-side current collecting electrode of the solid electrolytic capacitor 1.

As shown in FIG. 1, the solid electrolytic capacitor 1 includes a first principal surface 101 and a second principal surface 102. The first principal surface 101 and the second principal surface 102 face each other. This second principal surface 102 is at a side of a mounting surface of the solid electrolytic capacitor 1.

As shown in FIG. 2B, the capacitor element 10 includes a flat film-shaped anode electrode 11, a dielectric layer 12, and a CP layer (a solid electrolyte layer) 13.

Although a detailed structure is not illustrated in FIG. 2A, FIG. 2B, and FIG. 2C, the anode electrode 11 includes a large number of pores. In other words, the anode electrode 11 is in a porous state (a porous body (a porous portion)). The ratio of a thickness of the porous portion on one side of the anode electrode 11, a core metal portion, and the porous portion on the other side is about 1:1:1. The dielectric layer 12 covers the outer surface of the anode electrode 11. The detailed structure of the anode electrode 11 is not illustrated in FIG. 2A, FIG. 2B, and FIG. 2C, the dielectric layer 12 is illustrated so as to schematically cover a macroscopic surface of the anode electrode 11. Actually, the dielectric layer 12 covers not only the macroscopic surface of the anode electrode 11 but also a surface with the large number of pores of the anode electrode 11. It is to be noted that the anode electrode 11 corresponds to the “anode-electrode electrode foil” in the present disclosure.

The CP layer 13 covers the surface of the dielectric layer 12. The CP layer 13 is provided inside a frame-shaped first dam 14. The first dam 14 has insulating properties. The first dam 14 defines a region in which the CP layer 13 is provided. It is to be noted that, in the first exemplary embodiment, as described in a manufacturing method to be described below, the first dam 14 is formed in a frame shape, and then the CP layer 13 is formed inside the first dam 14. However, for example, in a case in which the capacitor element 10 is produced in an individualized state from the start, the first dam 14 does not need to be formed in a frame shape, depending on the method of manufacturing the capacitor element 10. In other words, the first dam 14 may be formed at one side or may be formed at two sides with a corner. Furthermore, the first dam 14 may be structured to be formed at two sides that face in a plan view.

The CP layer 13 has a structure in which an inner layer CP (an inner solid electrolyte layer) 131 and an outer layer CP (an outer solid electrolyte layer) 132 are stacked on each other. The inner layer CP 131 is provided on the surface of the dielectric layer 12, and the outer layer CP 132 is provided on a surface of the inner layer CP 131.

The plurality of capacitor elements 10 and the plurality of cathode electrodes 20 are alternately stacked so that respective flat film surfaces may be parallel to each other and may overlap with each other in a plan view.

A second dam 30 and a first adhesive agent 40 are disposed between adjacent capacitor element 10 and cathode electrode 20. The second dam 30 has insulating properties and adhesiveness. The first adhesive agent 40 has conductivity.

The second dam 30 is formed in a frame shape along the outer periphery of the surface in which the CP layer 13 and the cathode electrode 20 of the capacitor element 10 face each other. As shown in FIG. 2B, the second dam 30 is formed so as to overlap with the first dam 14. It is to be noted that the second dam 30 is made of an insulating material such as an insulating resin, for example.

The first adhesive agent 40 is disposed inside a frame defined by the second dam 30. This first adhesive agent 40 adheres the adjacent capacitor element 10 and cathode electrode 20.

In such a layered state, a first end 10E1 of the plurality of capacitor elements 10 is located at the same position in a side view. Similarly, a second end 10E2 of the plurality of capacitor elements 10 is located at the same position in the side view. Furthermore, a first end 20E1 of the plurality of cathode electrodes 20 is located at the same position in the side view. Similarly, a second end 20E2 of the plurality of cathode electrodes 20 is located at the same position in the side view. However, the same position also includes unintended variations in processing or the like, and may not be strictly the same position.

The first end 10E1 of the plurality of capacitor elements 10 and the second end 20E2 of the plurality of cathode electrodes 20 are placed near a first end of the capacitor element multilayer body 100. The first end 10E1 of the plurality of capacitor elements 10 projects more outward than the second end 20E2 of the plurality of cathode electrodes 20.

The second end 10E2 of the plurality of capacitor elements 10 and the first end 20E1 of the plurality of cathode electrodes 20 are placed near a second end of the capacitor element multilayer body 100. The first end 20E1 of the plurality of cathode electrodes 20 projects more outward than the second end 10E2 of the plurality of capacitor elements 10.

Such a structure achieves the capacitor element multilayer body 100.

It is to be noted that, in the above configuration, the configuration including the first adhesive agent 40 is described as an example. However, the CP layer 13 may be formed to be thicker or the CP layer (the solid electrolyte layer) including a binder instead of the first adhesive agent 40 may be formed. Even in such a case in which the first adhesive agent 40 is omitted, a structure in which the capacitor element 10 and the cathode electrode 20 are adhered to each other is able to be achieved.

The capacitor element multilayer body 100 is sealed with the insulating resin 50. More specifically, the insulating resin 50 covers the capacitor element multilayer body 100 except the first end 10E1 (the first end 10E1 of the anode electrode 11) of the plurality of capacitor elements 10 and the first end 20E1 of the plurality of cathode electrodes 20.

The metal film 61 covers an outer surface near the first end 10E1 of the anode electrode 11 and the first end 10E1 of the insulating resin 50. In other words, the metal film 61 is used as an anode-side current collecting electrode that connects the first end 10E1 of the anode electrode 11 of the plurality of capacitor elements 10. Moreover, the external terminal electrode 71 is formed so as to be in contact with the metal film 61.

Similarly, the metal film 62 covers an outer surface near the first end 20E1 of the cathode electrode 20 and the first end 20E1 of the insulating resin 50. In other words, the metal film 62 is used as a cathode-side current collecting electrode that connects the first end 20E1 of the cathode electrode 20 of the plurality of capacitor elements 10. Moreover, the external terminal electrode 72 is formed so as to be in contact with the metal film 62.

The above configuration achieves the solid electrolytic capacitor 1.

### Description of Detailed Structure of External Electrode

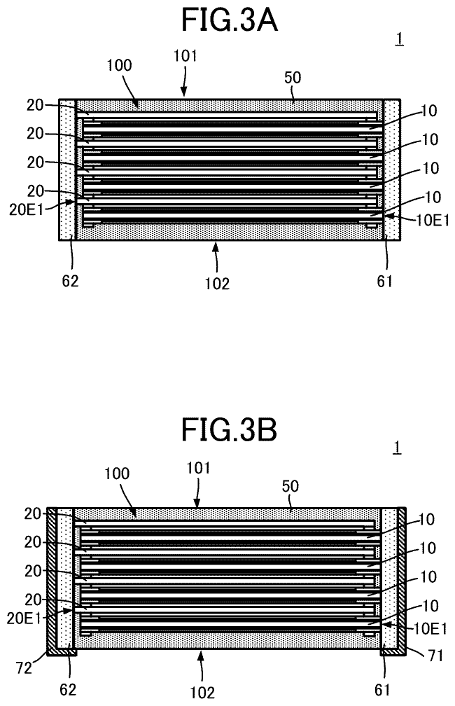

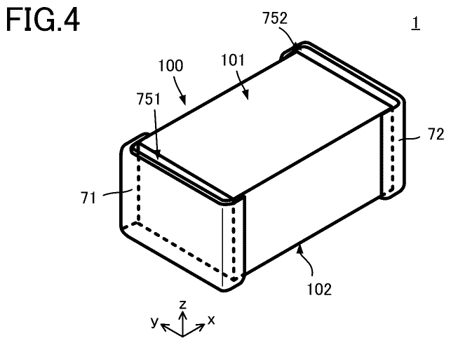

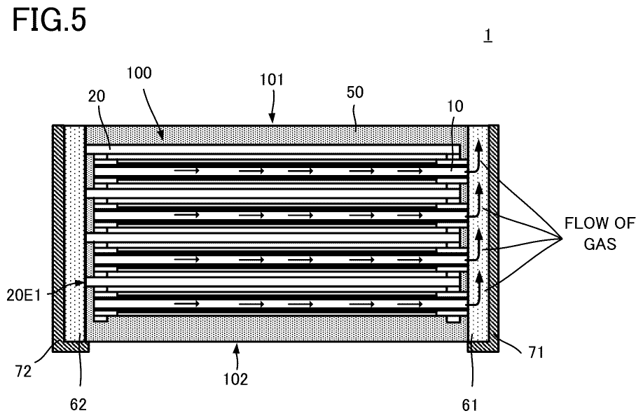

Next, a detailed structure of the metal films 61 and 62, and the external terminal electrodes 71 and 72 will be described with reference to FIG. 3A, FIG. 3B, FIG. 4, and FIG. 5. FIG. 3A is a view showing an overview in which the metal film 61 is formed near the first end 10E1 of the anode electrode 11 and the metal film 62 is formed near the first end 20E1 of the cathode electrode 20. In addition, FIG. 3B is a view showing an overview in which the external terminal electrode 71 and the external terminal electrode 72 are formed in the structure of FIG. 3A. FIG. 4 is an external perspective view showing an overview in which the external terminal electrodes 71 and 72 are provided in the capacitor element multilayer body 100. In order to make the structure of each of FIG. 3A, FIG. 3B, and FIG. 4 described above more understandable, each configuration is enlarged and is exaggerated.

As shown in FIG. 3A, the metal film 61 is formed by thermally spraying metal on the outer surface near the first end 10E1 of the anode electrode 11 and the first end 10E1 of the insulating resin 50. Similarly, the metal film 62 is formed by thermally spraying metal on the outer surface near the first end 20E1 of the cathode electrode 20 and the first end 20E1 of the insulating resin 50.

Next, as shown in FIG. 3B and FIG. 4, the external terminal electrode 71 is formed so as to be in contact with the metal film 61. In such a case, the external terminal electrode 71 covers a part near a mounting surface (near the second principal surface 102 of the capacitor element multilayer body 100) of the metal film 61. Then, the external terminal electrode 71 opens a side of a surface facing the mounting surface of the metal film 61. In other words, the external terminal electrode 71 is provided so as to have an opening 751 near the first principal surface 101.

In addition, as shown in FIG. 3B and FIG. 4, the external terminal electrode 72 is formed so as to be in contact with the metal film 62. In such a case, the external terminal electrode 72 covers a part near a mounting surface (near the second principal surface 102 of the capacitor element multilayer body 100) of the metal film 62. Then, the external terminal electrode 72 opens a side of a surface facing the mounting surface of the metal film 61. In other words, the external terminal electrode 72 is provided so as to have an opening 752 near the first main surface 101.

Herein, the detailed configuration of the metal films 61 and 62 will be described. A first pore diameter D1 of the metal films 61 and 62 is preferably larger than a second pore diameter D2 of the porous portion of the anode electrode 11. In such a case, the first pore diameter DI is an average pore diameter of the metal films 61 and 62, and the second pore diameter D2 is an average pore diameter of the anode electrode 11.

The law of conservation of mass is applied to a relationship between the first pore diameter D1 and the second pore diameter D2. In other words, the law (continuity equation) in which the mass flow rate of fluid to be led is always constant every cross-section is applied. That is to say, gas generated in the anode electrode 11 is discharged from the anode electrode 11 toward the metal films 61 and 62.

More specifically, since the first pore diameter D1 of the metal films 61 and 62 is larger than the second pore diameter D2 of the anode electrode 11, the gas generated in the anode electrode 11 easily flows from the anode electrode 11 toward the metal films 61 and 62 (see FIG. 5). As described above, since the external terminal electrode 71 is provided so as to have the opening 751 near the first principal surface 101, the gas flows toward the opening 751. Similarly, the external terminal electrode 72 is provided so as to have the opening 752 near the first principal surface 101. Therefore, the gas flows toward the opening 752.

In such a configuration, the gas generated in the anode electrode 11 during the MSL reflow, for example, is discharged to the outside without staying inside the solid electrolytic capacitor 1. That is to say, peeling or a crack due to the gas generated in the solid electrolytic capacitor 1 is significantly reduced.

In addition, the metal film 61 is formed by thermal spraying, so that this relationship is able to be easily achieved.

### Method of Manufacturing of Solid Electrolytic Condenser 1

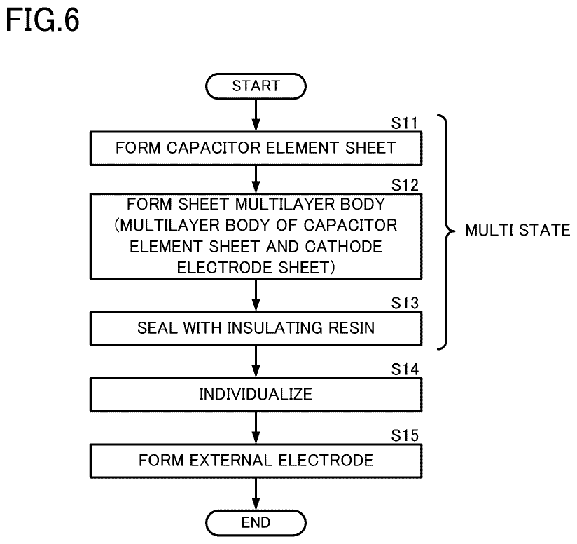

The solid electrolytic condenser 1 made of the above configuration is manufactured as follows, for example. FIG. 6 is a flowchart showing an example of a schematic flow of the method of manufacturing the solid electrolytic capacitor according to the present exemplary embodiment.

A capacitor element sheet is formed (FIG. 6: S11). A plurality of capacitor elements 10 that each provide a different solid electrolytic capacitor 1 are arrayed on the capacitor element sheet.

Next, the capacitor element sheet and a cathode electrode sheet are stacked on each other across the second dam 30 and the first adhesive agent 40 to form a sheet multilayer body (FIG. 6: S12). Moreover, a plurality of cathode electrodes 20 that each provide a different solid electrolytic capacitor 1 are arrayed on the cathode electrode sheet. As a result, a structure in which a plurality of capacitor element multilayer bodies 100 are planarly arrayed is formed. In other words, the sheet multilayer body is a planar array of the plurality of capacitor element multilayer bodies 100.

Next, the sheet multilayer body is sealed with an insulating resin 50 (FIG. 6: S13). Although the details will be described below, at this time, the sheet multilayer body includes a through hole that passes through the sheet multilayer body from the upper surface to the lower surface, and compression molding performs resin sealing.

Up to the sealing in this insulating resin 50, the method is performed in a multi state (a state in which a plurality of to-be solid electrolytic condensers 1 are arrayed) before the solid electrolytic condenser 1 is individualized.

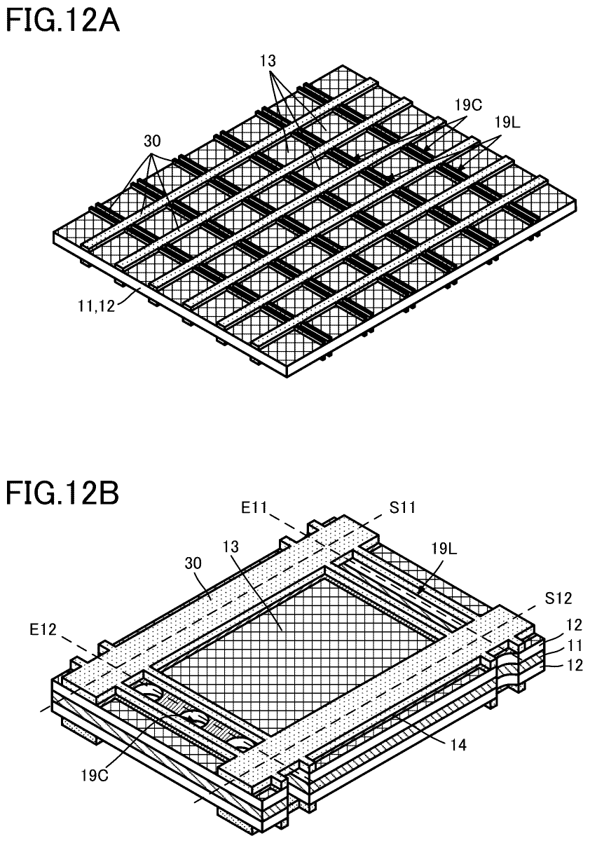

Next, the sheet multilayer body sealed with the insulating resin 50 is cut and individualized (FIG. 6: S14). Specifically, cutting is performed along cutting lines E11, E12, S11, and S12 shown in FIG. 12B to be described below. As a result, a plurality of solid electrolytic capacitors 1 (referred to as a base body of the solid electrolytic capacitor 1) without an external electrode are formed. Subsequently, secondary sealing of the insulating resin 50 is performed on the base body of the solid electrolytic capacitor 1. More specifically, side surfaces (surfaces cut with the cutting lines S11 and S12 (different side surfaces from an end surface to which an upper surface, a lower surface, the anode electrode 11, and the cathode electrode 20 are exposed)) of the base body of the solid electrolytic capacitor 1 is covered by the secondary sealing of the insulating resin 50. As a result, the anode electrode 11 and the cathode electrode 20 that unnecessarily expose during individualization are covered with the insulating resin 50.

Next, external electrodes configured by the metal films 61 and 62 and the external terminal electrodes 71 and 72 are formed on an end surface of the base body of the solid electrolytic capacitor 1 (FIG. 6: S15).

Next, each process step will be described in more detail.

### Process Step of Forming Capacitor Element Sheet

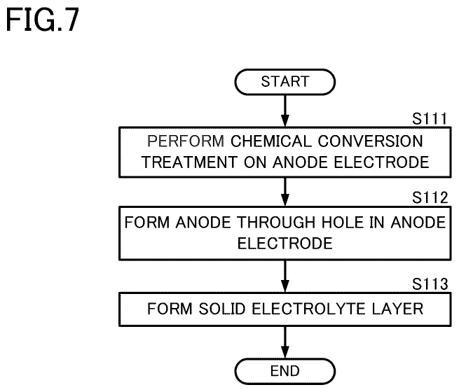

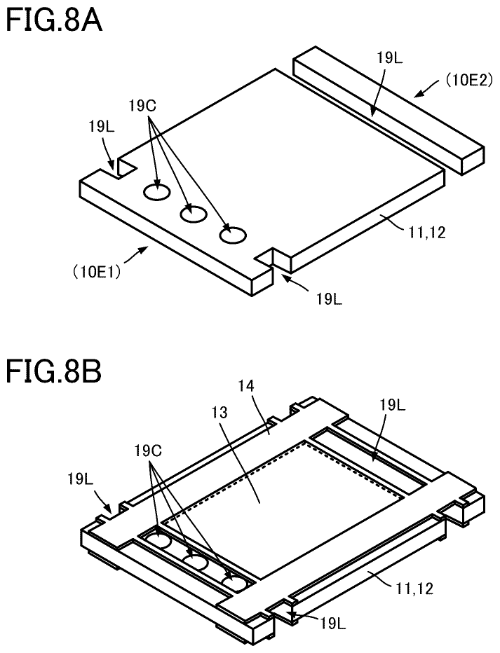

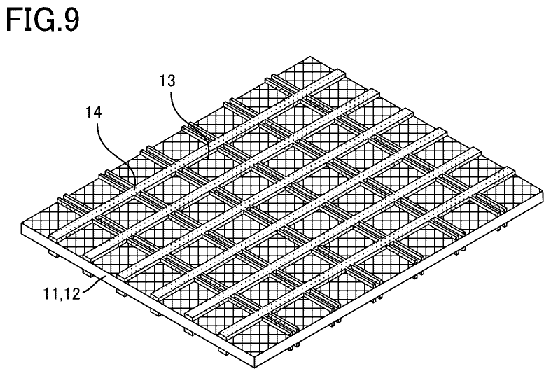

FIG. 7 is a flowchart showing an example of a process step of forming a capacitor element sheet. FIG. 8A is an external perspective view showing a shape of the anode electrode of the capacitor element before individualization, and FIG. 8B is an external perspective view showing a shape of the capacitor element before individualization. FIG. 9 is an external view in a multi state.

A chemical conversion treatment is performed on the anode electrode 11 to form a dielectric layer 12 (FIG. 7: S111). In this case, a large number of holes are formed on a surface of the anode electrode 11 by etching, and a vicinity of the surface of the anode electrode 11 is porous. The dielectric layer 12 covers the surface of the anode electrode 11 also including an inner surface of the pore.

Next, an anode-electrode through hole is formed in the anode electrode 11 (FIG. 7: S112). More specifically, as shown in FIG. 8A, a plurality of cylinder-shaped anode-electrode through holes 19C and groove-shaped anode-electrode through holes 19L are formed in the anode electrode 11. The plurality of cylinder-shaped anode-electrode through holes 19C and the groove-shaped anode-electrode through holes 19L are alternately arrayed in a direction in which portions to be used as a plurality of anode electrodes 11 are arranged. The plurality of cylinder-shaped anode-electrode through holes 19C are formed in positions in which the first end 10E1 of the anode electrode 11 is achieved. The groove-shaped anode-electrode through holes 19L are formed in positions over portions to be adjacent anode electrodes 11 and in a position in which a second end 10E2 of the adjacent anode electrodes 11 is achieved.

Next, a CP layer (a solid electrolyte layer) 13 is formed on the surface of the dielectric layer 12 (FIG. 7: S113). More specifically, as shown in FIG. 8B, a first dam 14 having a frame-shaped opening is formed. Then, the CP layer 13 (the layered structure of an inner layer CP 131 and an outer layer CP 132) is formed in the opening of the first dam 14.

This structure, as shown in FIG. 9, is performed in a multi state in which the plurality of capacitor elements 10 (the structure configured by the anode electrode 11, the dielectric layer 12, the CP layer 13, and the first dam 14) are arrayed in two dimensions.

### Process Step of Forming Cathode Electrode Sheet

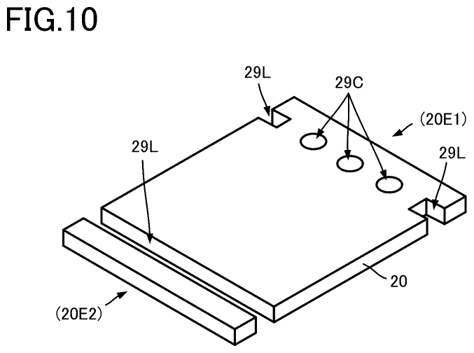

FIG. 10 is an external perspective view showing a shape of the cathode electrode before individualization.

As shown in FIG. 10, a plurality of cylinder-shaped cathode-electrode through holes 29C and groove-shaped cathode-electrode through holes 29L are formed in the cathode electrode 20. The plurality of cylinder-shaped cathode-electrode through holes 29C and the groove-shaped cathode-electrode through holes 29L are alternately arrayed in a direction in which portions to be used as a plurality of cathode electrodes 20 are arranged. The plurality of cylinder-shaped cathode-electrode through holes 29C are formed in positions in which the first end 20E1 of the cathode electrode 20 is achieved. The groove-shaped cathode-electrode through holes 29L are formed in positions over portions to be adjacent cathode electrodes 20 and in a position in which a second end 20E2 of the adjacent cathode electrodes 20 is achieved.

### Process Step of Forming Sheet Multilayer Body

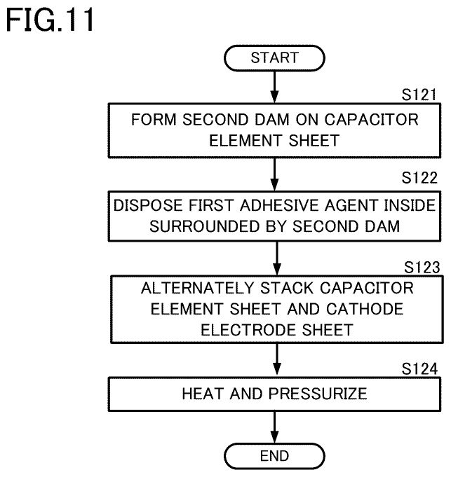

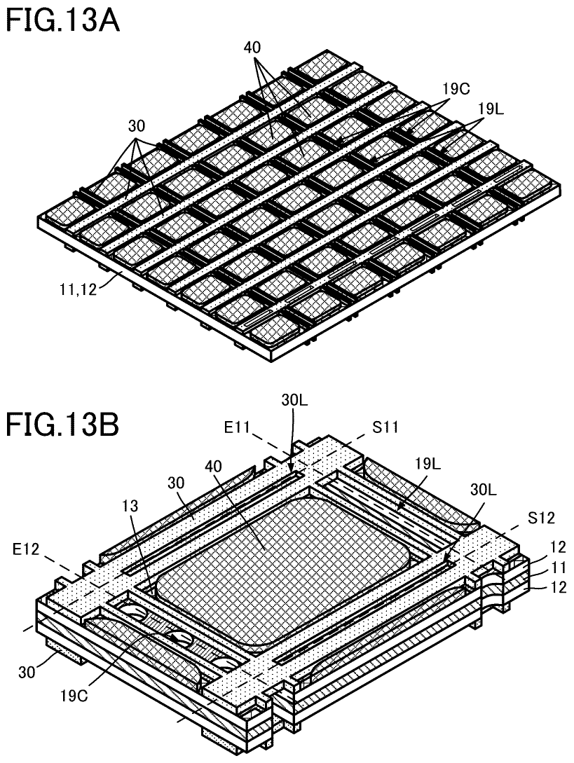

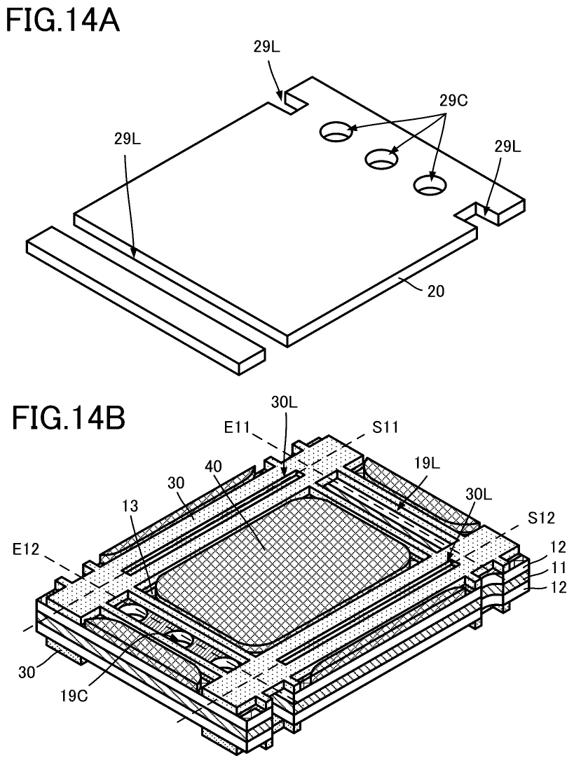

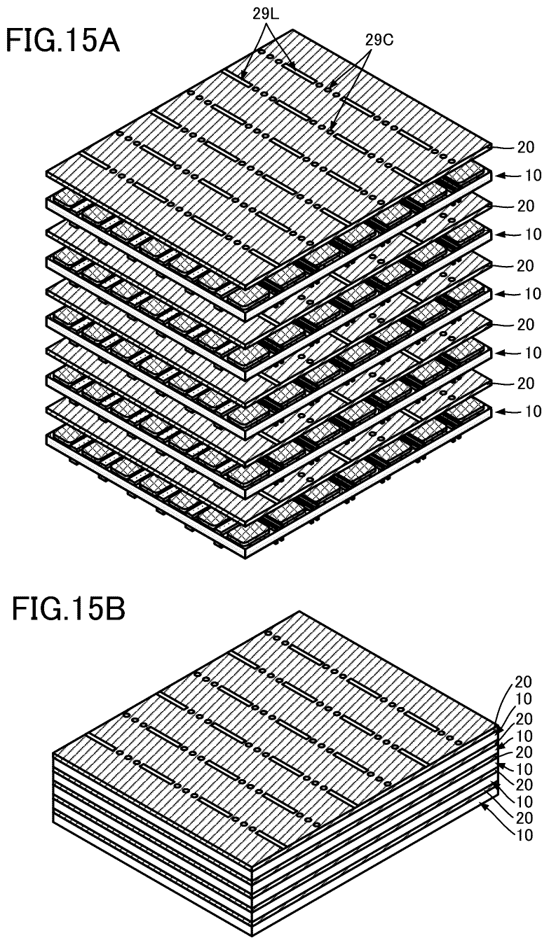

FIG. 11 is a flowchart showing an example of a process step of forming a sheet multilayer body. FIG. 12A and FIG. 12B are external perspective views showing a state in which a second dam is provided on a capacitor element sheet, FIG. 12A shows a multi state, and FIG. 12B shows a portion of one capacitor element. FIG. 13A and FIG. 13B are external perspective views showing a state in which a second dam and a first adhesive agent are provided on the capacitor element sheet, FIG. 13A shows a multi state, and FIG. 13B shows a portion of one capacitor element. FIG. 14A and FIG. 14B are exploded perspective views showing a state in which the capacitor element sheet and a cathode electrode sheet are stacked on each other. FIG. 14A and FIG. 14B show a portion corresponding to one solid electrolytic capacitor. FIG. 15A is a perspective view showing a state in which the capacitor element sheet in a multi state and the cathode electrode sheet are stacked on each other, and FIG. 15B is an external perspective view showing a state in which the capacitor element sheet in a multi state and the cathode electrode sheet are stacked on each other.

A second dam 30 is formed on the capacitor element sheet (FIG. 11: S121). More specifically, as shown in FIG. 12A and FIG. 12B, a second dam 30 having a frame-shaped opening is formed.

Next, as shown in FIG. 13A and FIG. 13B, a first adhesive agent 40 is disposed in the opening of the second dam 30 (FIG. 11: S122).

Next, as shown in FIG. 14A, FIG. 14B, FIG. 15A, and FIG. 15B, the capacitor element sheet and the cathode electrode sheet are alternately stacked on each other (FIG. 11: S123). More specifically, the capacitor element sheet and the cathode electrode sheet are stacked on each other so as to satisfy the following conditions.
Viewed in a stacking direction, the plurality of cylinder-shaped anode-electrode through holes 19C in the capacitor element sheet and the groove-shaped cathode-electrode through holes 29L in the cathode electrode sheet are overlapped with each other.
Viewed in the stacking direction, the groove-shaped anode-electrode through holes 19L in the capacitor element sheet and the plurality of cylinder-shaped cathode-electrode through holes 29C in the cathode electrode sheet are overlapped with each other.
Viewed in the stacking direction, the groove-shaped anode-electrode through holes 19L in the capacitor element sheet and the groove-shaped cathode-electrode through holes 29L in the cathode electrode sheet are overlapped with each other.

Then, a plurality of these through holes are formed according to the number of capacitor elements arrayed in the sheet multilayer body. Accordingly, the plurality of through holes that pass through from the upper surface to the lower surface of the sheet multilayer body are formed in the sheet multilayer body.

Next, the sheet multilayer body is heated and pressurized (FIG. 11: S124). As a result, the capacitor element sheet and the cathode electrode sheet are adhered by the first adhesive agent 40 to form the sheet multilayer body. It is to be noted that, as described above, in a case of a structure without the first adhesive agent 40, Step S122 is able to be skipped.

### Process Step of Forming Metal Film and External Terminal Electrode

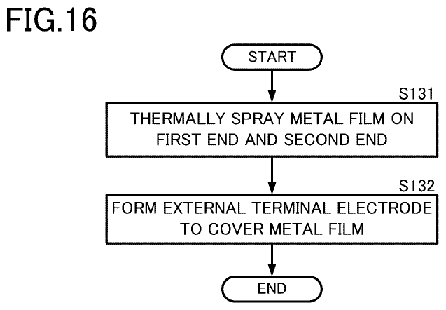

A process step of forming the metal films 61 and 62 and the external terminal electrodes 71 and 72 will be described with reference to FIG. 3A, FIG. 3B, and FIG. 16. FIG. 16 is a flowchart showing an example of a process step of forming a metal film and an external terminal electrode.

As shown in FIG. 3A, metal thermal spraying is performed on the outer surface near the first end 10E1 of the anode electrode 11 and the first end 10E1 of the insulating resin 50. Similarly, the metal thermal spraying is performed on the outer surface near the first end 20E1 of the cathode electrode 20 in the capacitor element multilayer body 100 and the first end 20E1 of the insulating resin 50 (FIG. 16: S131). As a result, the metal film 61 is formed on the first end 10E1. Similarly, the metal film 62 is formed on the first end 20E1.

Next, an example in which the external terminal electrodes 71 and 72 are directly formed with respect to the metal films 61 and 62, for example, by sputtering or the like will be described with reference to FIG. 3B. Specifically, the external terminal electrode 71 is formed so as to cover the metal film 61. Similarly, the external terminal electrode 72 is formed so as to cover the metal film 62. At this time, the external terminal electrode 71 is provided so as to have the opening 751 near the first principal surface 101. In addition, the external terminal electrode 72 is provided so as to have the opening 752 near the first main surface 101.

By use of such a solid electrolytic capacitor 1, the gas generated in the solid electrolytic capacitor 1 during the MSL reflow, for example, is discharged to the outside without staying inside the solid electrolytic capacitor 1. Therefore, peeling or a crack due to the gas generated in the solid electrolytic capacitor 1 is significantly reduced. That is to say, a solid electrolytic capacitor 1 with high reliability is able to be achieved.

It is to be noted that the above configuration shows a configuration formed by thermally spraying the metal films 61 and 62. However, as long as the first pore diameter D1 is configured to be larger than the second pore diameter D2, the metal films 61 and 62 may be formed by a method other than thermal spraying.

In addition, the above configuration shows a structure in which the metal film 62 and the external terminal electrode 72 are formed. However, in the present disclosure, the configuration may include at least the metal film 61 and the external terminal electrode 71 to be connected to the anode electrode 11 and may discharge the gas generated in the solid electrolytic capacitor 1 from the external electrode near the anode plate to the outside. That is to say, a configuration that forms the external electrode near the cathode by the conventionally used method, instead of the metal film 62 and the external terminal electrode 72 may be used.

It is to be noted that the above configuration shows a shape in which the external terminal electrodes 71 and 72 cover the entire side surfaces (the side of the first end 10E1 of the anode electrode 11 and the side of the first end 20E1 of the cathode electrode 20) of the solid electrolytic capacitor 1. However, the external terminal electrodes 71 and 72 may have a shape in which the metal films 61 and 62 is able to be partially exposed and the gas generated in the solid electrolytic capacitor 1 is able to be discharged to the outside. However, the shape that covers the entirety also includes unintended variations in processing or the like, and may not be strictly the shape that covers the entirety.

That is to say, the above configuration shows an example in which the opening 751 of the external terminal electrode 71 and the opening 752 of the external terminal electrode 72 are formed near the first principal surface 101. However, the positions of the openings 751 and 752 are not limited to the side of the first principal surface 101 and the positions to be formed are not limited as long as no problem in mounting occurs. For example, the openings 751 and 752 may be in any positions except a range to be covered with solder or a conductive adhesive agent during mounting and to be unable to discharge to the outside the gas generated in the solid electrolytic capacitor 1. Furthermore, the openings 751 and 752 may include the size, shape, and number of openings by which gas is able to be discharged.

### Second Exemplary Embodiment

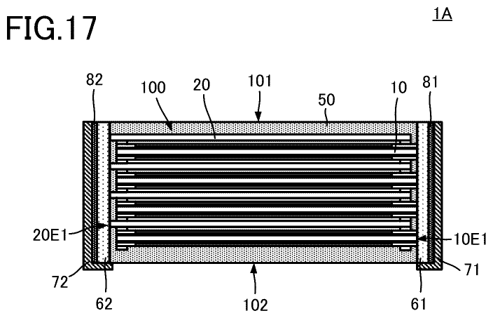

Next, a solid electrolytic capacitor according to a second exemplary embodiment of the present disclosure will be described with reference to the drawings. FIG. 17 is a side cross-sectional view showing an overview configuration of the solid electrolytic capacitor according to the second exemplary embodiment of the present disclosure.

As shown in FIG. 17, the solid electrolytic capacitor 1A according to the second exemplary embodiment is different from the solid electrolytic capacitor 1 according to the first exemplary embodiment in that a conductive resin layer is provided. Other configurations of the solid electrolytic capacitor 1A are the same as or similar to the configurations of the solid electrolytic capacitor 1, and a description of the same or similar configurations will be omitted.

In the second exemplary embodiment, an example in which the external terminal electrodes 71 and 72 in an already molded state are formed on the metal films 61 and 62 by a conductive adhesive agent will be described with reference to FIG. 17. Specifically, the metal thermal spraying is performed on the outer surface near the first end 10E1 of the anode electrode 11 and the first end 10E1 of the insulating resin 50, so that the metal film 61 is formed. A conductive resin layer 81 is formed so as to cover a surface (near the outer surface) facing the first end 10E1 in this metal film 61. Moreover, the external terminal electrode 71 is formed so as to cover the conductive resin layer 81.

Similarly, the metal thermal spraying is performed on the outer surface near the first end 20E1 of the cathode electrode 20 and the first end 20E1 of the insulating resin 50, so that the metal film 62 is formed. A conductive resin layer 82 is formed so as to cover a surface (near the outer surface) facing the first end 20E1 in this metal film 62. Moreover, the external terminal electrode 72 is formed so as to cover the conductive resin layer 82.

The second exemplary embodiment shows a structure in which the metal film 62 and the external terminal electrode 72 are formed. However, the configuration may include at least the metal film 61 and the external terminal electrode 71 to be connected to the anode electrode 11 and may discharge the gas generated in the solid electrolytic capacitor 1 from the external electrode near the anode plate to the outside. That is to say, a configuration that forms the external electrode near the cathode by the conventionally used method, instead of the metal film 62 and the external terminal electrode 72 may be used.

The adhesive strength of the metal film 61 and the external terminal electrode 71 that have been formed in such a manner is increased. Similarly, the adhesive strength of the metal film 62 and the external terminal electrode 72 is increased.

That is to say, an area in which the metal film 61 and the external terminal electrode 71 are in contact with each other and an area in which the metal film 62 and the external terminal electrode 72 are in contact with each other are able to be ensured, so that electrical conductivity is able to be ensured. Furthermore, the conductive resin layers 81 and 82 are able to significantly reduce peeling due to a difference of coefficients of linear expansion between the conductive resin layer 81, the metal film 61, and the external terminal electrode 71 and between the conductive resin layer 82, the metal film 62, and the external terminal electrode 72.

Similarly, the area in which the metal film 62 and the external terminal electrode 72 are in contact with each other is able to be ensured, the electrical conductivity is able to be ensured. Furthermore, the conductive resin layer 82 is able to significantly reduce peeling due to a difference of the coefficient of linear expansion between the metal film 62 and the external terminal electrode 72.

Even by use of such a solid electrolytic capacitor 1A, the gas generated in the anode electrode 11 during the MSL reflow, for example, is discharged to the outside without staying inside the solid electrolytic capacitor 1A. Therefore, peeling or a crack due to the gas generated in the solid electrolytic capacitor 1A is significantly reduced. Moreover, the electrical conductivity between the metal film 61, the conductive resin layer 81, and the external terminal electrode 71, and the metal film 62, the conductive resin layer 82, and the external terminal electrode 72. That is to say, a solid electrolytic capacitor 1A with high reliability is able to be achieved.

### Third Exemplary Embodiment

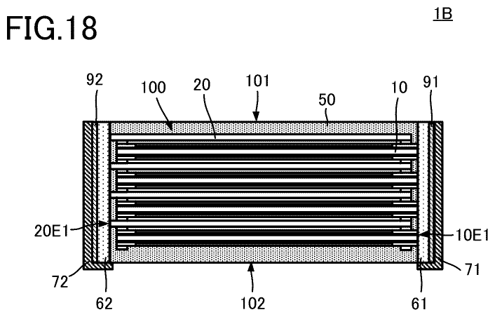

Next, a solid electrolytic capacitor according to a third exemplary embodiment of the present disclosure will be described with reference to the drawings. FIG. 18 is a side cross-sectional view showing an overview configuration of the solid electrolytic capacitor according to the third exemplary embodiment of the present disclosure.

As shown in FIG. 18, the solid electrolytic capacitor 1B according to the third exemplary embodiment is different from the solid electrolytic capacitor 1 according to the first exemplary embodiment in that a non-conductive resin layer is provided. Other configurations of the solid electrolytic capacitor 1B are the same as or similar to the configurations of the solid electrolytic capacitor 1, and a description of the same or similar configurations will be omitted.

As shown in FIG. 18, the metal thermal spraying is performed on the outer surface near the first end 10E1 of the anode electrode 11 and the first end 10E1 of the insulating resin 50, so that the metal film 61 is formed. A non-conductive resin layer 91 is formed so as to cover a surface (near the outer surface) facing the first end 10E1 in this metal film 61. In such a case, a part of the surface of the metal film 61 has a portion that is not covered with the non-conductive resin layer 91. Moreover, the external terminal electrode 71 is formed so as to cover the non-conductive resin layer 91. The shape of the non-conductive resin layer 91 can be any shape as long as the metal film 61 and the external terminal electrode 71 are able to be used as the anode electrode.

Similarly, the metal thermal spraying is performed on the outer surface near the first end 20E1 of the cathode electrode 20 and the first end 20E1 of the insulating resin 50, so that the metal film 62 is formed. A non-conductive resin layer 92 is formed so as to cover a surface (near the outer surface) facing the first end 20E1 in this metal film 62. In such a case, a part of the surface of the metal film 62 has a portion that is not covered with the non-conductive resin layer 92. Moreover, the external terminal electrode 72 is formed so as to cover the non-conductive resin layer 92. The shape of the non-conductive resin layer 92 can be any shape as long as the metal film 62 and the external terminal electrode 72 are able to be used as the cathode electrode.

The adhesive strength of the metal film 61 and the external terminal electrode 71 that have been formed in such a manner is increased. Similarly, the adhesive strength of the metal film 62 and the external terminal electrode 72 is increased.

That is to say, the non-conductive resin layers 91 and 92 are able to significantly reduce peeling due to a difference of coefficients of linear expansion between the conductive resin layer 81, the metal film 61, and the external terminal electrode 71 and between the conductive resin layer 82, the metal film 62, and the external terminal electrode 72.

Even by use of such a solid electrolytic capacitor 1B, the gas generated in the anode electrode 11 during the MSL reflow, for example, is discharged to the outside without staying inside the solid electrolytic capacitor 1B. Therefore, peeling or a crack due to the gas generated in the solid electrolytic capacitor 1B is significantly reduced. That is to say, a solid electrolytic capacitor 1B with high reliability is able to be achieved. In addition, the use of a non-conductive resin makes it possible to perform manufacturing at a lower cost in comparison with the use of a conductive resin in the second exemplary embodiment.

### Fourth Exemplary Embodiment

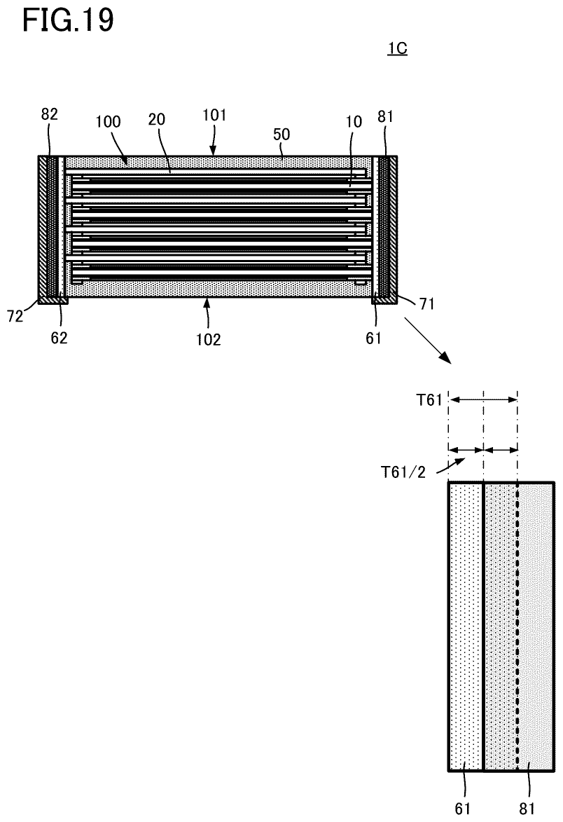

Next, a solid electrolytic capacitor according to a fourth exemplary embodiment of the present disclosure will be described with reference to the drawings. FIG. 19 is a side cross-sectional view showing an overview configuration of the solid electrolytic capacitor according to the fourth exemplary embodiment of the present disclosure.

As shown in FIG. 19, the solid electrolytic capacitor 1C according to the fourth exemplary embodiment is different in a configuration of a conductive resin layer from the solid electrolytic capacitor 1A according to the second exemplary embodiment. Other configurations of the solid electrolytic capacitor 1C are the same as or similar to the configurations of the solid electrolytic capacitor 1A, and a description of the same or similar configurations will be omitted.

As shown in FIG. 19, the conductive resin layer 81 penetrates to the metal film 61. More specifically, the conductive resin layer 81 penetrates to a half (T6½) of a thickness T61 of the metal film 61. However, the half of the thickness includes unintended variations in processing or the like and strictly also includes a thickness of which the conductive resin layer 81 is not the half of the thickness T61 of the metal film 61.

From the viewpoint of long-term use, oxygen or vapor may intrude from the outside to the metal film 61, and thus the inside of the solid electrolytic capacitor 1C deteriorates. However, the conductive resin layer 81 penetrates to a fixed thickness (approximately a half of the metal film 61, in the above example) of the metal film 61, so that the intrusion of oxygen or vapor is able to be significantly reduced.

That is to say, the above configuration makes it possible to achieve both discharge of gas to the outside of the solid electrolytic capacitor 1C and intrusion of oxygen or vapor from the outside to the solid electrolytic capacitor 1C.

It is to be noted that the fourth exemplary embodiment shows the configuration of the conductive resin layers 81 and 82. However, as in the third exemplary embodiment, even when the non-conductive resin layers 91 and 92 are used, the same or similar operational effects are able to be obtained.

### Description of Example such as Specific Material of Each Component of Solid Electrolytic Capacitor 1

### Capacitor Element 10

The capacitor element 10 is achieved, for example, by the following materials and thickness.

The anode electrode 11 is made of a metal simple substance such as aluminum, tantalum, niobium, titanium, zirconium, and magnesium, for example, an alloy containing such metals, or the like. It is to be noted that the anode electrode 11 is preferably made of aluminum or an aluminum alloy. The anode electrode 11 may be a valve metal that provides a so-called valve effect.

The anode electrode 11 preferably has a flat plate shape and the thickness of the core portion (central portion that the pore of the porous body does not reach) of the anode electrode 11 is preferably 5 μm to 100 μm. The thickness (thickness of one side) of the porous portion (the portion in which the holes of the porous body are formed) is preferably 5 μm to 200 μm.

The dielectric layer 12 is preferably made of an oxide film of the anode electrode 11. The dielectric layer 12, when an aluminum foil is used for the anode electrode 11, for example, is formed by oxidation treatment in an aqueous solution containing boric acid, phosphoric acid, adipic acid, or those sodium salt, ammonium salt, or the like. The thickness of the dielectric layer 12 is preferably 1 nm to 100 nm.

The inner layer CP 131 may be, for example, a layer of PEDOT: PSS achieved by a conductive polymer based on pyrroles, thiophenes, anilines, or the like, or by PEDOT [poly (3, 4-ethlenedioxythiophene)] of a conductive polymer based on thiophenes, or the like and compounded with polystyrene sulfonic acid (PSS) as a dopant. The inner layer CP 131 is formed by, for example, a method of using a treatment liquid containing a monomer such as 3,4-ethylenedioxythiophene to form a polymer film such as a poly (3, 4-ethylenedioxythiophene) film on the surface of the dielectric layer 12, a method of applying a dispersion liquid of a polymer such as poly (3,4-ethylenedioxythiophene) onto a surface of a dielectric portion and drying the dispersion liquid, or a similar method.

The thickness of the outer layer CP 132 is preferably 2 μm to 20 μm. The material of the outer layer CP 132 is the same as the material of the inner layer CP 131.

The first adhesive agent 40 may use a mixture of an insulating resin such as an epoxy resin and a phenol resin and a conductive particle such as carbon and silver, for example.

The cathode electrode 20 is formed of aluminum, titanium, copper, silver, or the like, for example. The thickness of the cathode electrode 20, for example, is smaller than or similar to the thickness of the anode electrode 11. It is to be noted that the thickness of the cathode electrode 20 is preferably as small as possible, is approximately 5 μm to 50μm, and is preferably about 30 μm.

The insulating resin 50 may include a filler. The resin preferably includes an epoxy resin, a phenol resin, a polyimide resin, a silicone resin, a polyamide resin, a liquid crystal polymer, for example. The filler preferably includes an insulating oxide particle such as a silica particle, an alumina particle, a titania particle, or a zirconia particle, for example. The maximum diameter of the filler, for example, is preferably 30 μm to 40 μm. For example, a material preferably includes a solid epoxy resin and a phenol resin that include a silica particle.

The metal films 61 and 62 are preferably formed of a thermally sprayable metal. The use of the thermal spraying is able to easily make the first pore diameter DI of the metal films 61 and 62 larger than the second pore diameter D2 of the porous portion of the anode electrode 11. This is considered because, when the metal film 61 is formed, for example, by thermal spraying, a comparatively large metal particle in a molten state or a half-molten state reaches the outer surface near the first end 10E1 of the anode electrode 11 and the first end 10E1 of the insulating resin 50, and the large metal particle is cooled and solidified, so that pores are easily formed. The same may be applied to the metal film 62.

The external terminal electrodes 71 and 72 preferably use Au, Cu, or a 42 alloy, for example. It is to be noted that the external terminal electrodes 71 and 72 may be made of be a material with high solder wettability to a surface of the external terminal electrodes 71 and 72.

The conductive resin layers 81 and 82 are made of a thermosetting resin having conductivity. An example may preferably include a phenol resin.

The non-conductive resin layers 91 and 92 are made of a thermosetting resin having non-conductivity. For example, an epoxy resin or the like may be preferable.

### REFERENCE SIGNS LIST

D1—first pore diameter
D2—second pore diameter
E11—cutting line
S11—cutting line
T61—thickness of metal film
1, 1A, 1B, 1C—solid electrolytic capacitor
10—capacitor element
10E1—first end
10E2—second end
11—anode electrode
12—dielectric layer
13—CP layer
131—inner layer CP
132—outer layer CP
14—first dam
19C—anode-electrode through hole
19L—anode-electrode through hole
20—cathode electrode
20E1—first end
20E2—second end
29C—cathode-electrode through hole
29L—cathode-electrode through hole
30—second dam
40—first adhesive agent
50—insulating resin
61, 62—metal film
71, 72—external terminal electrode
81, 82—conductive resin layer
91, 92—non-conductive resin layer
100—capacitor element multilayer body
101—first principal surface
102—second principal surface
751, 752—opening

1. A solid electrolytic capacitor comprising:
a sheet multilayer body having a plurality of flat film-shaped capacitor elements and a plurality of flat film-shaped cathode-electrode electrode foils alternately stacked with each other, each of the plurality of flat film-shaped capacitor elements comprising a flat film-shaped anode-electrode electrode foil having a porous portion in a predetermined depth from the surface, a dielectric layer on the porous portion, and a solid electrolyte layer on the dielectric layer;
a first metal portion at an end portion of the anode-electrode electrode foil; and
an insulating resin sealing the sheet multilayer body,
wherein a first pore diameter of the first metal portion is larger than a second pore diameter of the porous portion of the anode-electrode electrode foil.

2. The solid electrolytic capacitor according to claim 1, further comprising a second metal portion covering a part of the first metal portion.

3. The solid electrolytic capacitor according to claim 2, wherein the first metal portion has a portion thereof not covered by the second metal portion.

4. The solid electrolytic capacitor according to claim 2, wherein the first metal portion and the second metal portion are bonded to each other with a conductive resin.

5. The solid electrolytic capacitor according to claim 4, wherein the first metal portion has a portion thereof not covered by the conductive resin and the second metal portion.

6. The solid electrolytic capacitor according to claim 4, wherein the conductive resin penetrates to approximately ½ of a thickness of the first metal portion.

7. The solid electrolytic capacitor according to claim 2, further comprising a non-conductive resin in partial contact with the first metal portion and the second metal portion.

8. The solid electrolytic capacitor according to claim 7, wherein the non-conductive resin penetrates to approximately ½ of a thickness of the first metal portion.

9. The solid electrolytic capacitor according to claim 7, wherein the first metal portion has a portion thereof not covered by the non-conductive resin and the second metal portion.

10. The solid electrolytic capacitor according to claim 1, further comprising a second metal portion at an end portion of the cathode-electrode electrode foil.

11. The solid electrolytic capacitor according to claim 10, further comprising a third metal portion covering a part of the first metal portion and a fourth metal portion covering a part of the second metal portion.

12. The solid electrolytic capacitor according to claim 11, wherein the first metal portion has a portion thereof not covered by the third metal portion, and the second metal portion has a portion thereof not covered by the fourth metal portion.

13. The solid electrolytic capacitor according to claim 11, further comprising a conductive resin bonding the first metal portion and the third metal portion to each other, and bonding the second metal portion and the fourth metal portion to each other.

14. The solid electrolytic capacitor according to claim 13, wherein the first metal portion has a portion thereof not covered by the conductive resin and the second metal portion, and the second metal portion has a portion thereof not covered by the conductive resin and the fourth metal portion.

15. The solid electrolytic capacitor according to claim 13, wherein the conductive resin penetrates to approximately ½ of a thickness of the first metal portion.

16. The solid electrolytic capacitor according to claim 11, further comprising a non-conductive resin in partial contact with the first metal portion and the third metal portion and in partial contact with the second metal portion and the fourth metal portion.

17. The solid electrolytic capacitor according to claim 16, wherein the non-conductive resin penetrates to approximately ½ of a thickness of the first metal portion.

18. The solid electrolytic capacitor according to claim 16, wherein the first metal portion has a portion thereof not covered by the non-conductive resin and the third metal portion, and the second metal portion has a portion thereof not covered by the non-conductive resin and the fourth metal portion.
